(19) United States
(12) Patent Application Publication
(10) Pub. No.: US 2003/0225847 A1
(43) Pub. Date: Dec. 4, 2003

(54) Sending instant messaging personalization items

(76) Inventors: Brian Heikes, Ashburn, VA (US); James A. Odell, Potomac Falls, VA (US); Justin Uberti, Sterling, VA (US); Andrew L. Wick, McLean, VA (US); Xiaoyan Yin, Fairfax Station, VA (US); Xiaopeng Zhang, Oak Hill, VA (US)

Correspondence Address: FISH & RICHARDSON P.C., 1425 K STREET, N.W., 11TH FLOOR, WASHINGTON, DC, 20005-3500, US

(21) Appl. No.: 10/334,128

(22) Filed: Dec. 31, 2002

Related U.S. Application Data
(63) Continuation-in-part of application No. 10/305,015, filed on Nov. 27, 2002.
(60) Provisional application No. 60/384,147, filed on May 31, 2002.
(60) Provisional application No. 60/416,902, filed on Oct. 9, 2002.

(51) Int. Cl. G06F 15/16

(52) U.S. Cl. 709/207

(57) ABSTRACT

Perception of wallpaper in an instant messaging communications session may be enabled by rendering, on an instant message recipient system, an instant messaging application user interface for an instant messaging communications session involving at least one instant message recipient and an instant message sender, receiving a message that includes a text message and wallpaper to be displayed by the IM recipient when perceiving the text message, the wallpaper being selected by the instant message sender system, and rendering the wallpaper at the instant message recipient system when rendering another portion of the message.

This application claims priority from U.S. Provisional Application No. 60/384,147, filed May 31, 2002, and U.S. Provisional Application No. 60/416,902, filed Oct. 9, 2002, and is a continuation-in-part of U.S. application Ser. No. 10/305,015, filed Nov. 27, 2002, all of which are incorporated by reference.

### TECHNICAL FIELD

This description relates to instant messaging communications and more particularly to communicating wallpaper associated with a sender of instant messaging communications.

### BACKGROUND

Online service providers facilitate access to information and services by providing interactive User Interfaces (UIs) that help users navigate to desired resources. For example, in the case of a system for communicating using instant messages (IMs), a UI allows an IM sender to invoke actions, such as establishing a communications link, through the selection of screen objects such as icons, windows, and drop-down menus. The design of a UI has a significant impact on an IM sender's online experience. In particular, the icons, the windows, and the menus of a UI may be arranged to enable an IM sender to locate information and services quickly and easily.

### SUMMARY

Techniques are described for IM customization. In one general aspect, perception of wallpaper in an instant messaging communications session may be enabled by rendering, on an instant message recipient system, an instant messaging application user interface for an instant messaging communications session involving at least one instant message recipient and an instant message sender, receiving a message that includes a text message and wallpaper to be displayed by the IM recipient when perceiving the text message, the wallpaper being selected by the instant message sender system, and rendering the wallpaper at the instant message recipient system when rendering another portion of the message.

Implementations may include one or more of the following features. For example, receiving the message includes receiving wallpaper that has been automatically selected by the instant message sender system. Receiving the message may also include receiving at least a portion of the wallpaper in an instant message from an instant message sender system, in a message generated upon a change in a presence state of the IM sender, or at least a portion of the wallpaper may be provided by a host other than the instant message host. The wallpaper may be enabled to be rendered in consideration of a payment. Also, the wallpaper may be configured to expire upon the occurrence of a predetermined event such as passage of a predetermined length of time or passage of a predetermined date, or a predetermined number of uses. If it is determined that the predetermined event has occurred, display of the wallpaper may be disallowed. If it is determined that the wallpaper has been banned, display of the wallpaper may be disallowed. The determination of whether the wallpaper has been banned may be based, for example, on a report by a user or on a violation of a term of service agreement.

In another general aspect, transportation of wallpaper in an instant messaging communications session may be enabled by rendering, on an instant message sender system, an instant messaging application user interface for an instant messaging communications session involving at least one instant message recipient and an instant message sender, accessing wallpaper to be displayed by an instant message recipient, the wallpaper being selected by the instant message sender system, selecting an instant message recipient, and sending a message to the selected instant message recipient, the message including at least a portion of the wallpaper associated with the instant message sender.

Implementations may include one or more of the following features. For example, wallpaper may be automatically selected by the instant message sender system. Wallpaper may be accessed on the instant message sender system or on an instant message host system, including a host system than an instant message host system.

Wallpaper may be selected by the instant message sender system, and may be stored on an instant message host system or on the instant message sender system.

The wallpaper may be sent in a message generated upon a change in a presence state of the IM sender, and at least a portion of the wallpaper may be provided by a host other than an instant message host. The wallpaper may be enabled to be rendered in consideration of a payment and may be configured to expire upon the occurrence of a predetermined event such as the passage of a predetermined length of time or passage of a predetermined date, or a predetermined number of uses. If it is determined that wallpaper has expired based on determining whether the predetermined event has occurred, sending of the wallpaper may be disallowed. If it determined that the wallpaper has been banned, sending of the wallpaper may be disallowed. The determination of whether the wallpaper has been banned may be based, for example, on a report by a user or on a violation of a term of service agreement.

The wallpaper may be provided by a third party such as a server other than the IM host, and may be enabled to be rendered in consideration of a payment. The wallpaper also may be configured to expire upon the occurrence of a predetermined event such as, for example, the passage of a predetermined length of time, the passage of a predetermined date, or a predetermined number of uses.

Aspects of the IM customization techniques may be implemented by an apparatus and/or by a computer program stored on a computer readable medium. The computer readable medium may comprise a disc, a client device, a host device, and/or a propagated signal. In addition, aspects of the IM customization techniques may be implemented in a client/host context or in a standalone or offline client device. The IM wallpaper may be rendered in a client/host context and may be accessed or updated through a remote device in a client/host environment. The IM wallpaper also may be rendered by the standalone/offline device and may be accessed or updated through a remote device in a non-client/host environment such as, for example, a LAN server serving an end user or a mainframe serving a terminal device.

Other features will be apparent from the following description, including the drawings, and from the claims.

### DESCRIPTION OF DRAWINGS

FIGS. 1-4 are block diagrams of an exemplary communications system.

FIGS. 5 and 9 are flow charts of exemplary processes that may be implemented by systems such as those of FIGS. 1-4.

FIGS. 6-8 and 10-13 are illustrations of different graphical user interfaces that may be implemented by systems such as those of FIGS. 1-4 when executing processes such as those of FIGS. 5 and 9.

Like reference symbols in the various drawings indicate like elements. For brevity, several elements in the figures described below are represented as monolithic entities. However, as would be understood by one skilled in the art, these elements each may include numerous interconnected computers and components designed to perform a set of specified operations and/or may be dedicated to a particular geographic region.

### DETAILED DESCRIPTION

Wallpaper associated with or selected by a sending party (sender) may be rendered by a receiving party (recipient) in an area associated with messages received from the sender, for instance, as a chrome (i.e., border) around a dialog area on a user interface. Such wallpaper may be sent or otherwise communicated by the sender to the recipient.

Moreover, wallpaper selected by the sender may be made available to a recipient by embedding and sending the wallpaper to the recipient in a message sent by the sender such as an instant message, or sending them with or in association with such a message. The wallpaper may be sent by the sender system to the recipient system, with a message or through a separate negotiation or communication, and also may be stored locally on the recipient system.

In one implementation, the sender's wallpaper may be contained in an instant message from the sender to the recipient, or in a computer-to-computer message, not under control of the sender or the recipient, from sender system to recipient system. In another implementation, a portion of the item is included in a message, and the item is progressively rendered to the recipient with the receipt of each successive message. In yet another implementation, a portion of the item is included in the message, and the recipient system waits over the course of one or more successive messages for the receipt of entire item before rendering the item. In this sense, a first communication by the sender may trigger a series of successive communications of the wallpaper or portions of the wallpaper to enable an iterative communication of that wallpaper that may occur in the background and without delaying receipt of the sender's original message and without delaying rendering of the wallpaper pending further overt communication between the sender and the recipient.

Upon receipt of the wallpaper, the IM recipient system renders the wallpaper for perception by the IM recipient.

Although wallpaper may be rendered at any time, wallpaper typically is rendered upon the occurrence of one or more particular events. For example, wallpaper selected by an IM sender may be made perceivable to an IM recipient during an IM conversation. In one instance, wallpaper selected by the IM sender appears on the IM recipient system when a message is received from the IM sender or when a message is returned to the IM sender by the IM recipient. As another example, the wallpaper may be displayed by the IM recipient system when changes are experienced in presence or state of the IM sender or other IM participant with whom they communicate (e.g., when the IM sender or other IM participant logs on, logs off, becomes inactive, or enables or disables the IM recipient's ability to detect the IM sender's presence).

Wallpaper may be rendered for an IM sender and/or an IM recipient at the IM sender system, the IM recipient system, or both. The IM wallpaper of the IM sender and the IM recipient may be rendered at the same time or at different times. Wallpaper of the IM recipient may be rendered at the IM sender system in a manner similar to that used to render wallpaper of the IM sender at the IM recipient system.

An IM sender may choose to have different wallpaper displayed for different IM recipients, and an IM recipient may choose to have different wallpaper displayed for different IM senders. Once a wallpaper is designated by an IM sender or an IM recipient, the wallpaper typically is made available for perception by the IM recipient or the IM sender automatically. The wallpaper also may be selected automatically for an IM sender or an IM recipient based upon a characteristic of the IM sender or the IM recipient.

In one implementation, an IM recipient may not change the wallpaper of an IM sender, and an IM sender may not change the wallpaper of an IM recipient.

Typically, IM communications involve an instantaneous or nearly instantaneous communication between two users, where each user is able to transmit, receive and display communicated information. Additionally, although IM communications may occur in the absence of online presence information, IM communication generally involves the display and perception of online presence information regarding other selected users (“buddies”). After a communication session is established or authentication is performed, the IM communications may be machine-to-machine communications that occur without intervention by or communication through an instant messaging server. Examples of IM communications exist over AIM (America Online Instant Messenger), AOL (America Online) Buddy List and Instant Messenger, Yahoo Messenger, MSN Messenger, and ICQ, among others.

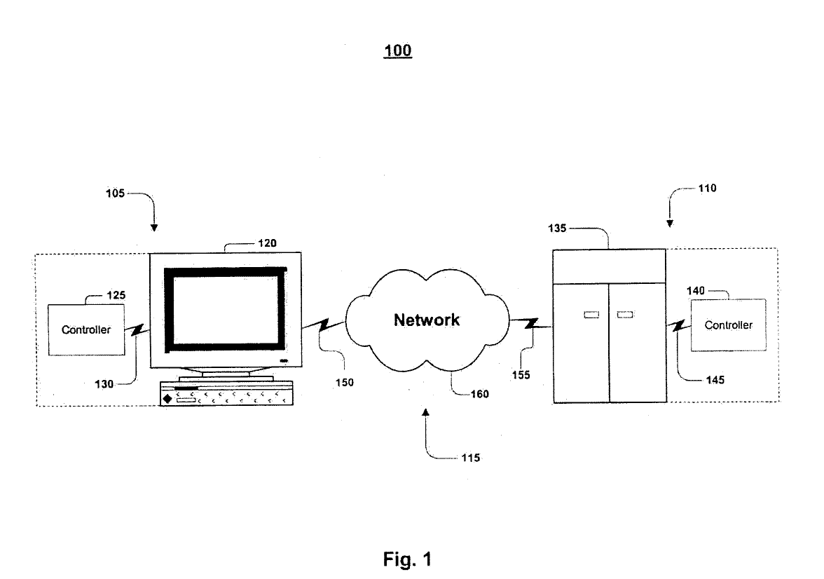

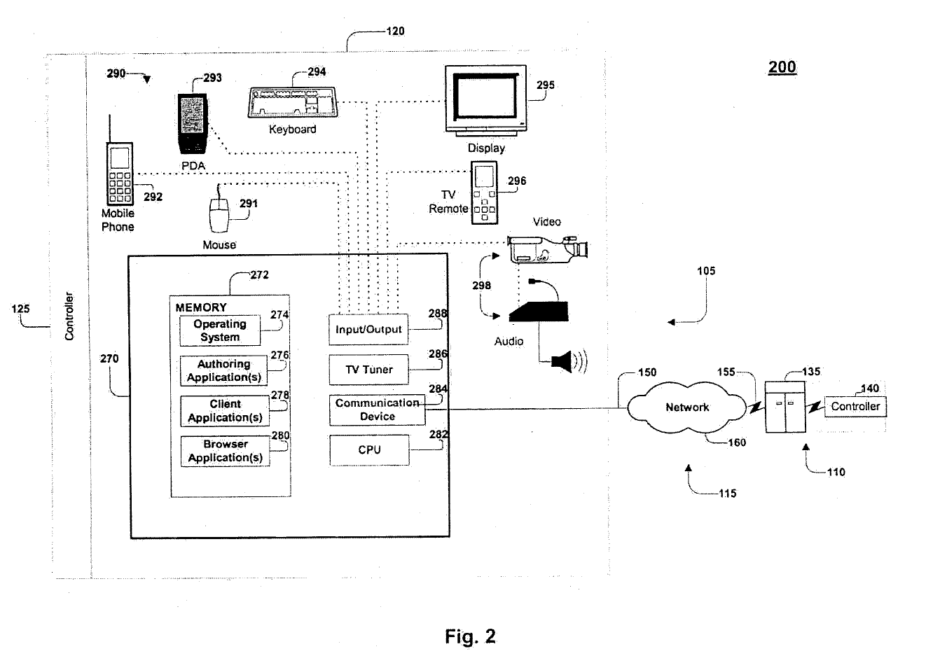

For illustrative purposes, FIGS. 1 and 2 show an example of a communications system for implementing techniques for transferring electronic data.

Referring to FIG. 1, a communications system 100 is capable of delivering and exchanging data between an IM sender system 105 and a host system 110 through a communications link 115. The IM sender system 105 typically includes one or more client devices 120 and/or client controllers 125, and the host system 110 typically includes one or more host devices 135 and/or host controllers 140. For example, the IM sender system 105 or the host system 110 may include one or more general-purpose computers (e.g., custom computers), one or more special-purpose computers (e.g., devices specifically programmed to communicate with each other and/or the IM sender system 105 or the host system 110), or a combination of one or more general-purpose computers and one or more special-purpose computers. The IM sender system 105 and the host system 110 may be arranged to operate within or in concert with one or more other systems, such as, for example, one or more LANs (“Local Area Networks”) and/or one or more WANs (“Wide Area Networks”).

The client device 120 and the host device 135 are generally capable of executing instructions under the command of, respectively, a client controller 125 and a host controller 140. The client device 120 and the host device 135 are connected to, respectively, the client controller 125 and the host controller 140 by, respectively, wired or wireless data pathways 130 and 145, which are capable of delivering data.

The client device 120, the client controller 125, the host device 135, and the host controller 140 typically each include one or more hardware components and/or software components. An example of a client device 120 or a host device 135 is a general-purpose computer (e.g., a custom computer) or software on such a computer capable of responding to and executing instructions in a defined manner. Other examples include a special-purpose computer, a workstation, a server, a device, a component, other physical or virtual equipment or some combination of these capable of responding to and executing instructions. The client device 120 and the host device 135 may include devices that are capable of establishing peer-to-peer communications.

An example of client controller 125 or host controller 140 is a software application loaded on the client device 120 or the host device 135 for commanding and directing communications enabled by the client device 120 or the host device 135. Other examples include a program, a piece of code, an instruction, a device, a computer, a computer system, or a combination of these for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 and the host device 135.

The communications link 115 typically includes a delivery network 160 that provides direct or indirect communication between the IM sender system 105 and the host system 110, irrespective of physical separation. Examples of a delivery network 160 include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

FIG. 2 illustrates a communications system 200 including an IM sender system 105 communicating with a host system 110 through a communications link 115.

The IM sender system 105 includes a client device 120 that typically includes a general-purpose computer 270 having an internal or external memory 272 for storing data and programs such as an operating system 274 (e.g., DOS, Windows™, Windows 95™, Windows 98™, Windows 2000™, Windows Me™, Windows XP™, Windows NT™, OS/2, or Linux) and one or more application programs. Examples of application programs include authoring applications 276 (e.g., word processing programs, database programs, spreadsheet programs, or graphics programs) capable of generating documents or other electronic content; client applications 278 (e.g., America Online (AOL) client, CompuServe client, AOL Instant Messenger (AIM) client, interactive television (ITV) client, Internet Service Provider (ISP) client, or instant messaging (IM) client) capable of communicating with other computer users, accessing various computer resources, and viewing, creating, or otherwise manipulating electronic content; and browser applications 280 (e.g., Netscape's Navigator or Microsoft's Internet Explorer) capable of rendering standard Internet content and other content formatted according to standard protocols such as the Hypertext Transfer Protocol (HTTP).

One or more of the application programs may be installed on the internal or external storage 272 of the general-purpose computer 270. Alternatively, in another implementation, the client controller 125 may access application programs externally stored in and/or performed by one or more device(s) external to the general-purpose computer 270.

The general-purpose computer 270 also includes a central processing unit 282 (CPU) for executing instructions in response to commands from the client controller 125, and a communication device 284 for sending and receiving data. One example of the communication device 284 is a modem. Other examples include a transceiver, a set-top box, a communication card, a satellite dish, an antenna, a network adapter, or some other mechanism capable of transmitting and receiving data over the communications link 115 through a wired or wireless data pathway 150. The general-purpose computer 270 optionally includes a television (“TV”) tuner 286 for receiving television programming in the form of broadcast, satellite, and/or cable TV signals. The TV tuner 286 permits the client device 120 to selectively and/or simultaneously display network content received by communications device 284 and TV programming content received by the TV tuner 286.

The general-purpose computer 270 may include an input/output interface 288 that enables wired or wireless connection to various peripheral devices 290. Examples of peripheral devices 290 include, but are not limited to, a mouse 291, a mobile phone 292, a custom digital assistant (PDA) 293, an MP3 player (not shown), a keyboard 294, a display monitor 295 with or without a touch screen input, a TV remote control 296 for receiving information from and rendering information to users, and an audiovisual input device 298.

Although FIG. 2 illustrates devices such as a mobile telephone 292, a PDA 293, and a TV remote control 296 as being peripheral with respect to the general-purpose computer 270, in another implementation, such devices may themselves include the functionality of the general-purpose computer 270 and operate as the client device 120. For example, the mobile phone 292 or the PDA 293 may include computing and networking capabilities and function as a client device 120 by accessing the delivery network 160 and communicating with the host system 110. Furthermore, the IM sender system 105 may include one, some or all of the components and devices described above.

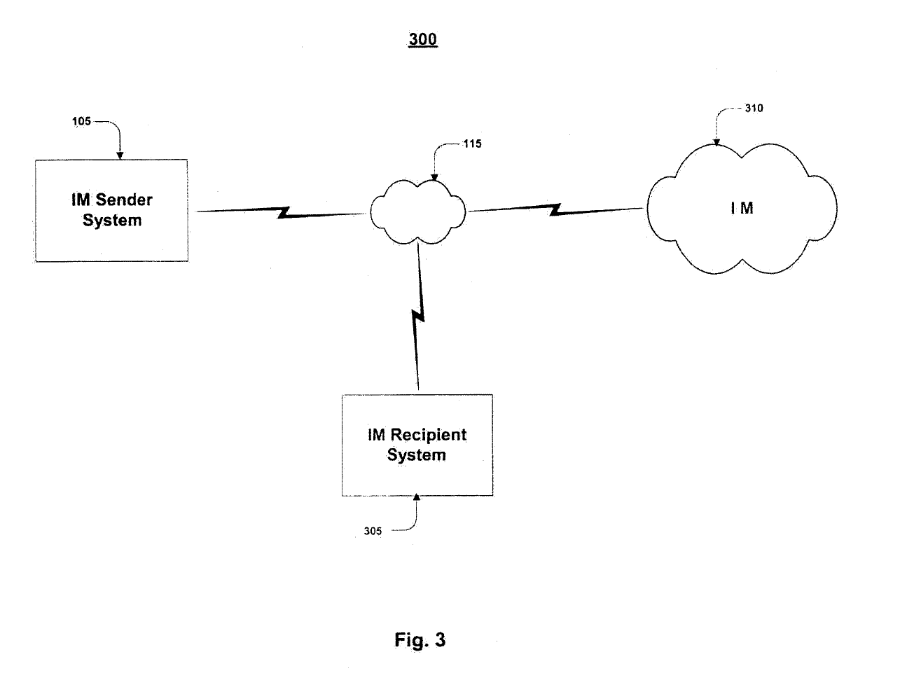

FIG. 3 illustrates a communications system 300 including an IM sender system 105 communicating with an IM recipient system 305 and an IM host system 310 through a communication link 115. Such a communications system may be used by users of IM service providers, such as, for example, AIM, ICQ, Yahoo Messenger, and Microsoft Messenger.

In one implementation, the IM host system 310 may have characteristics similar to those described above with respect to the host system 110, the IM recipient system 305 may have characteristics similar to those described above with respect to the IM sender system 105, and the IM sender system 105 and the IM recipient system 305 may include communication software to enable users of the client systems to access the IM host system 310.

The IM host system 310 may support IM services irrespective of an IM sender's network or Internet access. Thus, the IM host system 310 may allow users to send and receive IMs, regardless of whether they have access to any particular ISP. The IM host system 310 also may support associated services, such as administrative matters, advertising, directory services, chat, and interest groups related to the IM. The IM host system 310 has an architecture that enables the devices (e.g., servers) within the IM host system 310 to communicate with each other. To transfer data, the IM host system 310 employs one or more standard or exclusive IM protocols.

To access the IM host system 310 to begin an IM session in the implementation of FIG. 3, the IM sender system 105 establishes a connection to the IM host system 310. Once a connection to the IM host system 310 has been established, the IM sender system 105 may directly or indirectly transmit data to and access content from the IM host system 310. By accessing the IM host system, an IM sender can use the IM client application to view whether particular users (“buddies”) are online, exchange IMs with particular buddies, participate in group chat rooms, trade files such as pictures, invitations or documents, find other buddies with similar interests, get customized information such as news and stock quotes, and search the Web. IM recipient system 305 may be similarly manipulated to establish contemporaneous connection with IM host system 310.

Once connectivity is established, an IM sender who is using IM sender system 105 may view whether an IM recipient using IM recipient system 305 is online, and typically may view whether the IM recipient is able to receive IMs. If the IM recipient is online, the IM sender may exchange IMs with the IM recipient.

In one implementation, the IMs sent between IM sender system 105 and IM recipient system 305 are routed through IM host system 310. In another implementation, the IMs sent between IM sender system 105 and IM recipient system 305 are routed through a third party server (not shown), and, in some cases, are also routed through IM host system 310. In yet another implementation, the IMs are sent directly between IM sender system 105 and IM recipient system 305.

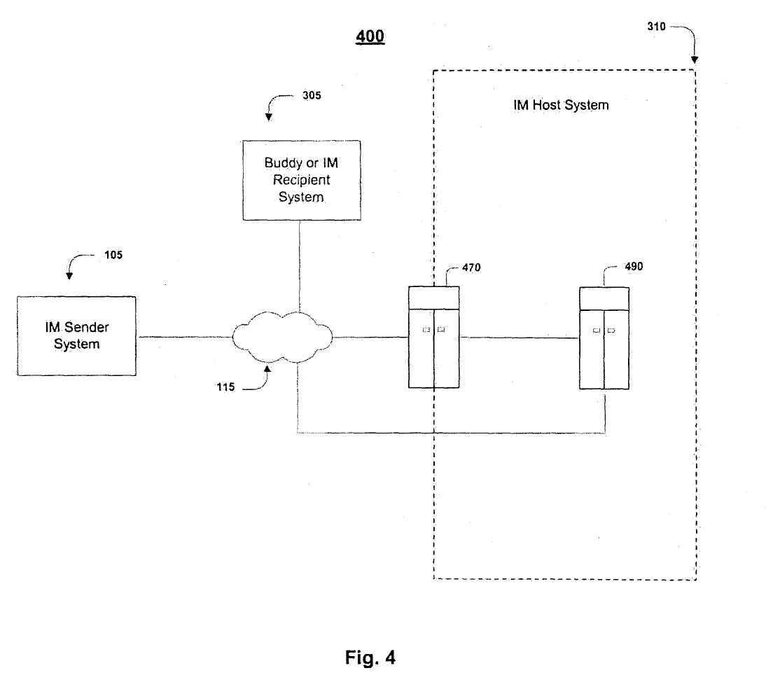

FIG. 4 illustrates a communications system 400 including an IM sender system 105 communicating with an IM recipient system 305 and an IM host system 310 through a communication link 115. System 400 illustrates a possible implementation of the communications system 300 of FIG. 3.

In system 400, the IM host system 310 includes a login server 470 for enabling access by users and routing communications between the IM sender system 105 and other elements of the IM host system 310. The IM host system 310 also includes an IM server 490. To enable access to and facilitate interactions with the IM host system 310, the IM sender system 105 and the IM recipient system 305 may include communication software, such as for example, an OSP client application and/or an IM client application.

As described with respect to FIG. 3, the IM host system 310 may support IM services irrespective of an IM sender's network or Internet access. Thus, the IM host system 310 may allow users to send and receive IMs, regardless of whether they have access to any particular ISP. The IM host system 310 also may support associated services, such as administrative matters, advertising, directory services, chat, and interest groups related to the IM. The IM host system 310 has an architecture that enables the devices (e.g., servers) within the IM host system 310 to communicate with each other. To transfer data, the IM host system 310 employs one or more standard or exclusive IM protocols.

In one implementation, the IM sender system 105 establishes a connection to the login server 470 in order to access the IM host system 310 and begin an IM session. The login server 470 typically determines whether the particular IM sender is authorized to access the IM host system 310 by verifying the IM sender's identification and password. If the IM sender is authorized to access the IM host system 310, the login server 470 usually employs a hashing technique on the IM sender's screen name to identify a particular IM server 490 within the IM host system 310 for use during the IM sender's session. The login server 470 provides the IM sender (e.g., IM sender system 105) with the IP address of the IM server 490, gives the IM sender system 105 an encrypted key, and breaks the connection. The IM sender system 105 then uses the IP address to establish a connection to the particular IM server 490 through the communications link 115, and obtains access to the IM server 490 using the encrypted key. Typically, the IM sender system 105 will be able to establish an open TCP connection to the IM server 490. The IM recipient system 305 establishes a connection to the IM host system 310 in a similar manner.

In one implementation, the IM sender system 105 may directly or indirectly transmit data to and access content from the IM server 490 once a connection to the IM server 490 has been established. By accessing the IM server, an IM sender can leverage the IM client application to determine whether particular users (“buddies” or potential IM recipients) are online, exchange IMs with particular buddies, participate in group chat rooms, trade files such as pictures, invitations or documents, find other buddies with similar interests, get customized news and stock quotes, and search the Web. For example an IM sender who is using IM sender system 105 may view whether a buddy using IM recipient system 305 is online, and if so, may exchange IMs with that buddy. In one implementation, the IMs sent between IM sender system 105 and IM recipient system 305 are routed through IM host system 310. In another implementation, the IMs sent between IM sender system 105 and IM recipient system 305 are routed through a third party server (not shown) and, in some cases, are also routed through IM host system 310. In yet another implementation, the IMs are sent directly between IM sender system 105 and IM recipient system 305.

In one implementation, the IM host system 310 also includes a user profile server (not shown) connected to a database (not shown) for storing large amounts of user profile data. The user profile server may be used to enter, retrieve, edit, manipulate, or otherwise process user profile data. In one implementation, an IM sender's profile data includes, for example, the IM sender's screen name, buddy list, identified interests, and geographic location. The IM sender may enter, edit and/or delete profile data using an installed IM client application on the IM sender system 105 to interact with the user profile server.

Because the IM sender's data are stored in the IM host system 310, the IM sender does not have to reenter or update such information in the event that the IM sender accesses the IM host system 310 using a new or different IM sender system 105. Accordingly, when an IM sender accesses the IM host system 310, the IM server can instruct the user profile server to retrieve the IM sender's profile data from the database and to provide, for example, the IM sender's buddy list to the IM server. Alternatively, user profile data may be saved locally on the IM sender system 105.

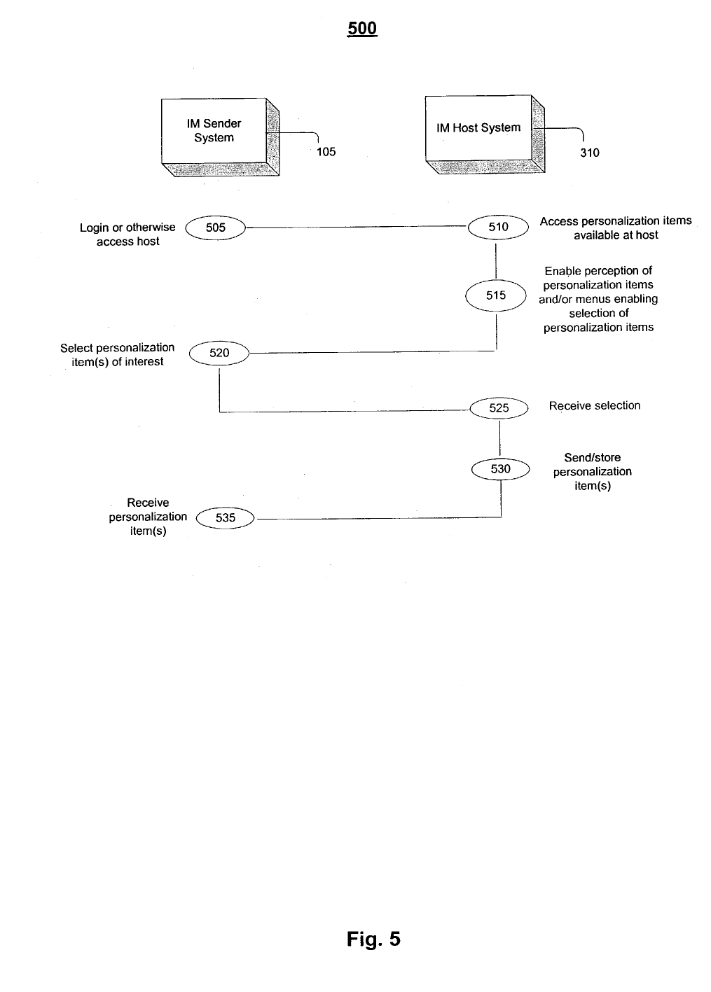

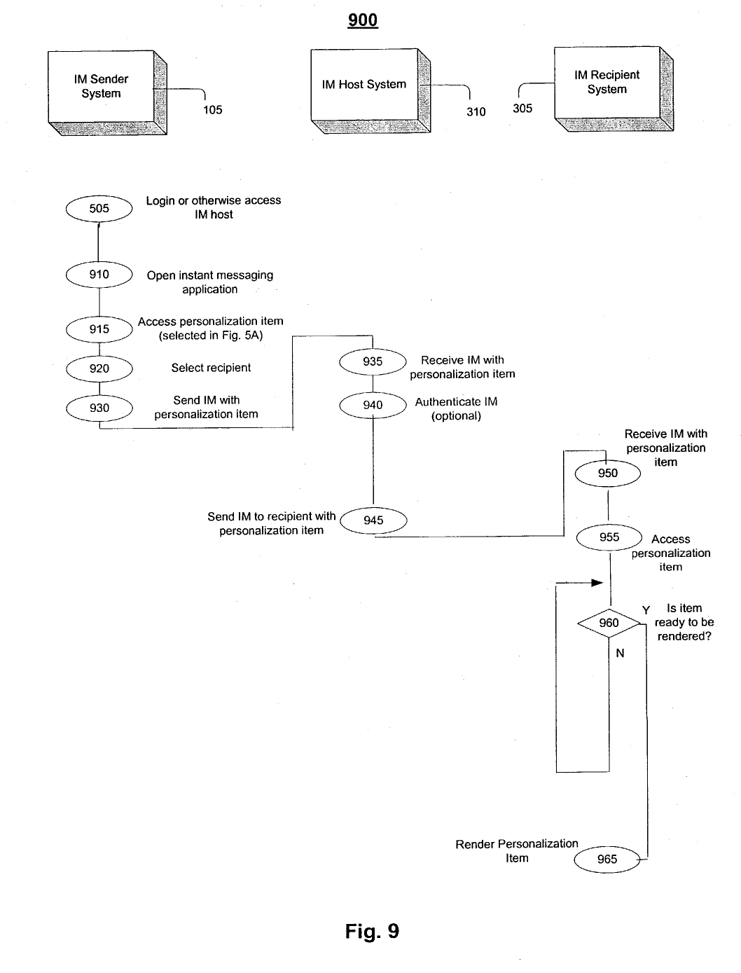

Referring to FIGS. 5 and 9, the IM sender system 105 and the IM host system 310 interact according to exemplary procedure 500 to enable an IM sender to select a wallpaper, and the IM sender system 105, the IM host system 310, and the IM recipient system 305 interact according to exemplary procedure 900 to make the wallpaper selected in procedure 500 perceivable to the IM recipient.

Procedures 500 and 900 may be implemented by any type of hardware, software, device, computer, computer system, equipment, component, program, application, code, storage medium, or propagated signal. Although not shown in FIGS. 5 and 9, the IM sender system 105 and the IM host system 310 may be directly or indirectly interconnected through known or described delivery networks, examples of which are described with respect to network 160.

Procedures 500 and 900 may be implemented in a client/host context, or a standalone or offline client context. For example, while some functions of procedures 500 and 900 may be performed entirely by the IM sender system 105 or the IM recipient system 305, other functions may be performed by the IM host system 310 or the collective operation of the IM sender system 105, and/or the IM recipient system 305, and/or the IM host system 310. The wallpaper may be respectively selected and rendered by the standalone/offline device, and the wallpaper may be accessed or updated through a remote device in a non-client/host environment such as, for example, a LAN server serving an end user or a mainframe serving a terminal device. Thus, the procedures 500 and 900 described below may be implemented for any OSP, ISP, browser and/or other software program having a graphical user interface, such as programs for instant messaging, chat, electronic mail and stand-alone browsers.

Procedure 500 generally involves selecting a wallpaper. In the procedure 500, the IM sender system 105 logs into or otherwise accesses the IM host system 310 (step 505). For instance, IM sender system 105 may connect to the IM host system 310 across a network (e.g., network 160) by supplying credentials to a server (e.g., a login server). More specifically, a browser may be used to access a web-available interface, an instant message may be used to access a selectable interface, or an IM client that has an interface to a host may be used, among other options.

The IM host system 310 accesses wallpaper appropriate for and selectable by the IM sender system 105 (step 510). In one implementation, the IM host system 310 may use a screen name of the IM sender system 105 or another identification of the IM sender system 105 to select/identify wallpaper available to the IM sender system 105.

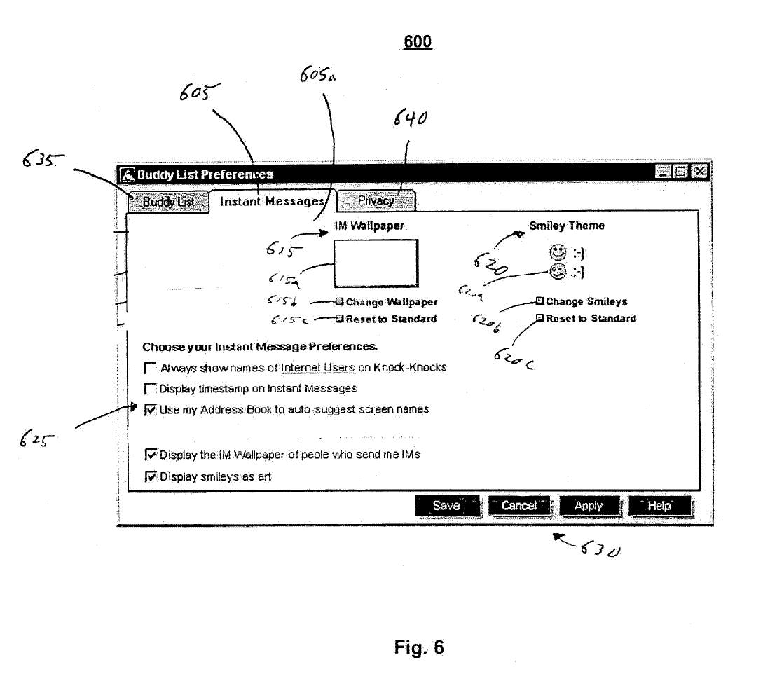

Next, the IM host system 310 enables perception by the IM sender system 105 of wallpaper and/or menus enabling the selection of wallpaper by the IM sender system 105 (step 515). FIGS. 6-8 describe various interfaces available to the user, which may be used to select wallpaper.

Based on the wallpaper or menus provided or otherwise made perceivable to the IM sender system, the IM sender system selects wallpaper of interest (step 520).

The IM sender may have selected wallpaper from a location including the IM sender system 105, the IM host system 310, or another host system. When the IM sender chooses wallpaper that is locally stored on the IM sender system 105, an identifier may be created for the chosen wallpaper based upon a hash of the item data. The identifier, when sent to the a remote location such as the IM host 310, may be checked to determine if the chosen wallpaper is already known to the host system, and if so, whether the wallpaper is designated as, for example, an official item. This allows the IM sender to select wallpaper from the IM sender's own client system, but prevents the host system or other remote location from needing to store duplicate copies of the same items. Also, the host system or other remote location is able to determine if such items are specially designated as, for example, official items and may be rendered to users who desire to view only items so designated.

The IM host system 310 receives the wallpaper selection from the IM sender system 105 (step 525), and responsive thereto, the IM host system 310 sends and/or stores one or more of the selected wallpaper (step 530). The IM host system 310 may store the item(s) in a memory or other storage, either local or remote to the IM host system 310. The IM host system 310 also may send the item(s) to the IM sender system 105 in a communication such as an instant message, or in communication associated with such a message.

Finally, the IM sender system 105 receives the selected wallpaper (step 535). The items may include information allowing the wallpaper to be rendered by the IM recipient system. For example, the wallpaper may include a type identifier that identifies the wallpaper as wallpaper. Also, the wallpaper may include one or more flags to indicate, for example, if the wallpaper is a custom item or an “official” item, has been banned, or has expired. The wallpaper may further include information concerning its size. The wallpaper may be in a predetermined format and may be of a predetermined length.

The relative order of steps 505-535 with respect to other steps in procedure 500, and also with respect to each other, may vary. Furthermore, certain steps may be omitted entirely, as appropriate.

FIG. 6 illustrates one example of an IM sender UI 600 for enabling an IM sender to select wallpaper (e.g., see step 520 of FIG. 5). The UI 600 may be presented to an IM sender of an IM service provider. In general, the UI 600 is rendered on the IM sender system 105 using software stored on the IM sender system 105. The wallpaper to be selected by the IM sender may be stored on the IM sender system 105, on the IM host system 310, or on a different host system 110 such as a host system of an authorized partner.

The UI 600 includes menu tabs 605, 635 and 640 that each have a corresponding menu to assist the IM sender with selecting wallpaper. For example, as shown in FIG. 6, the menu 605a corresponding to menu tab 605 enables an IM sender to make selections of wallpaper 615, and, for example, smiley (i.e., emoticon) themes 620. The IM sender's current selections of wallpaper 615a, and smiley theme 620a are displayed.

A control 615b is provided to enable selection of wallpaper 615a, and a control 615c is provided to enable reset of the wallpaper selection back to a default setting. Another control 620b is provided to enable a smiley theme 620a, and a control 620c is provided for the IM sender to reset the smiley theme selection back to a default setting.

Other controls 625 are provided for functions such as, for example, showing the names of users who are not on a buddy list, displaying a timestamp on instant messages, using an address book to automatically suggest screen names, displaying the wallpaper of people who send instant messages to the IM sender, and displaying smileys as art. Controls 630 are provided for the IM sender to save the changes made, apply the changes, cancel the changes, or get help.

If the IM sender's wallpaper selection is not available, a suitable message may be displayed to the IM sender informing the IM sender that the item is not available, and a link may be provided to an interface, such as one of the interfaces shown in FIGS. 6-8, to allow the IM sender to select another wallpaper.

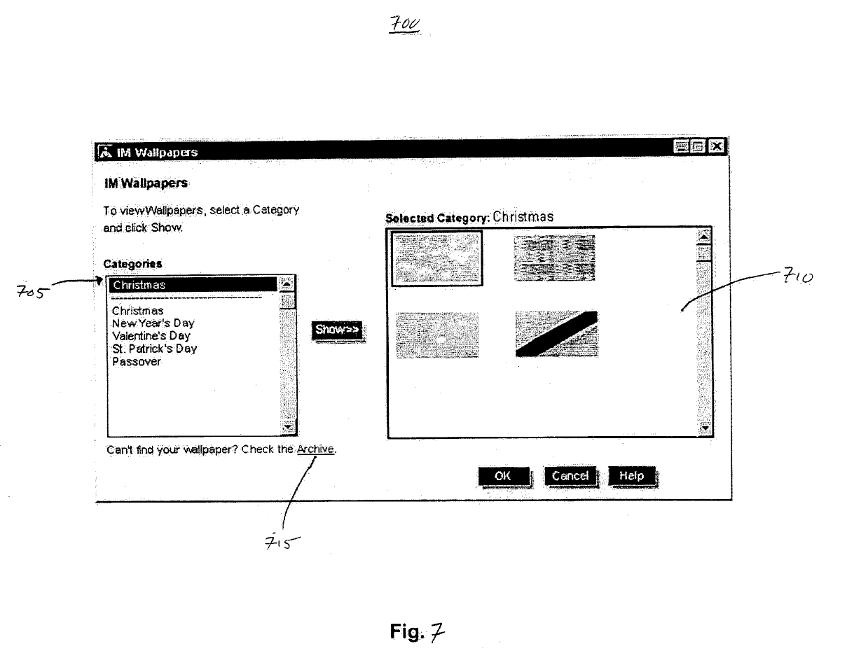

FIG. 7 illustrates an example of a UI 700 for enabling an IM sender to select wallpaper. The UI 700 is rendered in response to user manipulation of a control 615b (shown in FIG. 6). In the example of FIG. 7, the IM sender is presented with a list of wallpaper categories 705. When an IM sender selects a category 705, a window 710 displays the wallpaper available in the selected category. The IM sender may select a wallpaper by, for example, using a mouse or other input device to make a selection among the available items in the window 710. Also, an archive 715 of old wallpaper may be provided for user selection. In another implementation, the IM sender may provide a custom wallpaper.

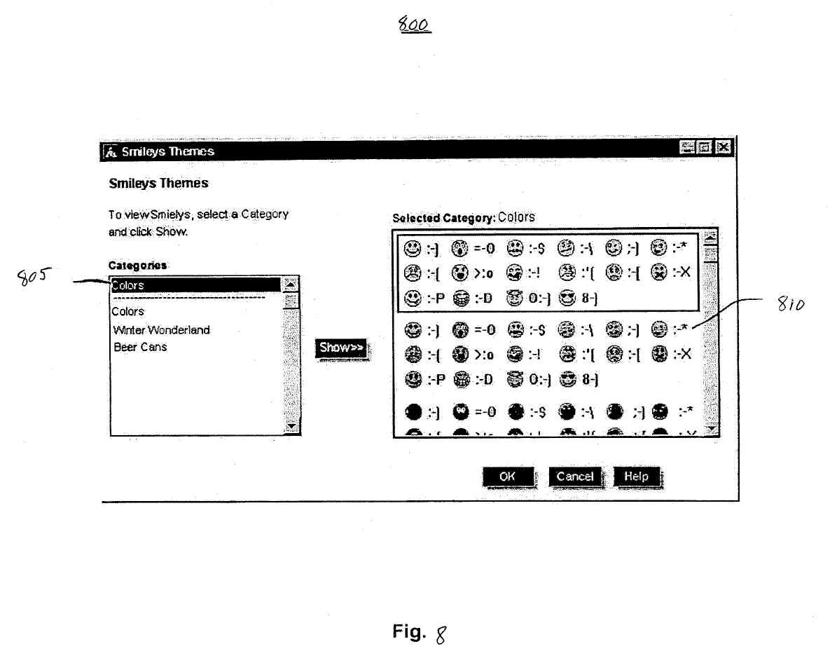

FIG. 8 illustrates an example of a UI 800 for enabling an IM sender to select smiley themes. The UI 800 is rendered in response to user manipulation of a control 620b (shown in FIG. 6). In the example of FIG. 8, the IM sender is presented with a list of smiley theme categories 805. When an IM sender selects a category 805, a window 810 displays the wallpaper available in the selected category. The IM sender may select wallpaper by, for example, using a mouse or other input device to make the selection among the available items in the window 810. Also, an archive of old wallpaper may be provided for IM sender selection. In another implementation, the IM sender may provide a custom smiley theme.

As discussed with respect to FIGS. 6-8, the wallpaper perception and selection may be assisted by user interfaces 600, 700 and 800, and the IM sender may make the selection using a mouse or other input device. Wallpaper may be selected manually by the IM sender or the wallpaper may be automatically selected for the IM sender.

Procedure 900 generally involves transporting and rendering wallpaper. In procedure 900, the IM sender system 105 accesses the IM host system 310 as described with respect to FIG. 5 (505).

The IM sender opens an IM application on the IM sender system 105 (step 910). Examples of IM applications include AIM and ICQ.

As shown in FIG. 6, an IM sender may open an IM application by acting on general actionable item 620.

Next, one or more wallpaper are selected, for example, in the manner discussed with respect to FIG. 5, and the selected items are accessed by the IM sender system 105 (step 915). As discussed with respect to FIGS. 6-8 the selection may be made with the assistance of IM sender interfaces 600, 700, and 800, and the IM sender may make the selection using a mouse or other input device. The wallpaper may be selected manually by the IM sender or may be automatically selected for the IM sender. Typically, the items are stored at the IM sender system 105. However, the items may be stored at other locations such as the IM host system 310 or another host system.

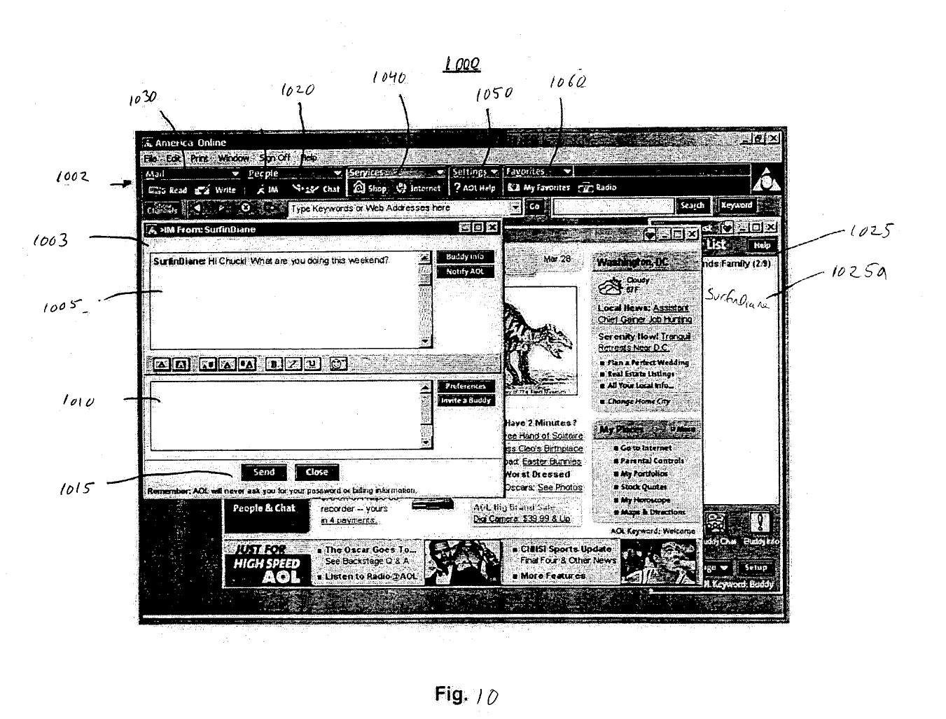

Next, an IM recipient is selected (step 920). For example, as shown with respect to FIG. 10, a buddy 1025a may be selected from a buddy list 1025.

Thereafter, an instant message, including the selected wallpaper, is generated by the IM sender system 105 and sent to the IM recipient system 305 (step 930). The IM sender system 105 need not supply the IM host system 310 with the selected wallpaper. Rather, the IM host system 310 may append or otherwise communicate the wallpaper to the IM recipient, even if a message without wallpaper is sent by the IM sender system 105, based upon the host having knowledge of the wallpaper selected by the IM sender system 105, or based upon an identifier that may be provided by the IM sender system 105 to the IM host system 310 rather than the wallpaper itself.

The IM host system 310 receives the instant message and the item (step 935). The IM host system 310 then may optionally authenticate the instant message for security purposes (step 940)

The IM host system 310 sends the IM message and the selected wallpaper(s) to the IM recipient system 305 (step 945).

The IM recipient system 305 receives the IM with the wallpaper(s) from the IM host system 310 (step 950). The wallpaper(s) may be received in a single message, or portions of the wallpaper(s) may be transported in more than one message and the complete wallpaper assembled at the IM recipient system 305.

The IM recipient system 305 accesses the wallpaper(s) or portions of the wallpaper(s) available at the IM recipient system (step 955).

Next, the IM recipient system 305 determines whether the wallpaper is ready to be rendered (step 960).

If the corresponding wallpaper is ready for rendering, the IM recipient system 305 renders the wallpaper (step 965), as described below with respect to step 965. The wallpaper may be ready for rendering in its entirety if the entire wallpaper has been received. The IM recipient system 305 may wait until the entire wallpaper is received to render the wallpaper. Otherwise, the wallpaper may be progressively rendered by the IM recipient system 305.

If the wallpaper is not available for rendering, the IM recipient system 305 waits until the wallpaper is available for rendering.

The relative order of steps 910-965 with respect to other steps in procedure 900, and also with respect to each other, may vary. For example, a recipient may be selected in step 920 before accessing wallpaper in step 915.

FIG. 10 illustrates an example of a UI 1000 that may be presented to a user of an online service provider. The UI 1000 includes a toolbar 1002 for quickly enabling activation of features such as, for example, reading or writing e-mail, exchanging IM messages with another user, entering chat areas with other users, shopping or accessing the internet. The toolbar 1002 may include one or more general interface actionable items 1020-1060, each of which is configured to enable activation of an associated user interface. An actionable item may be, for example, a button or a tab. For example, general actionable item 1020 is configured to enable activation of associated Instant Message (IM) interface 1003. IM interface 1003 represents a distinct and concurrent communications session. A buddy list 1025 is provided, and includes a list of the intended IM recipient and may include other potential IM recipients. As shown in interface 1003, the IM sender is able to view a communications session with IM recipient “SurfinDiane.”

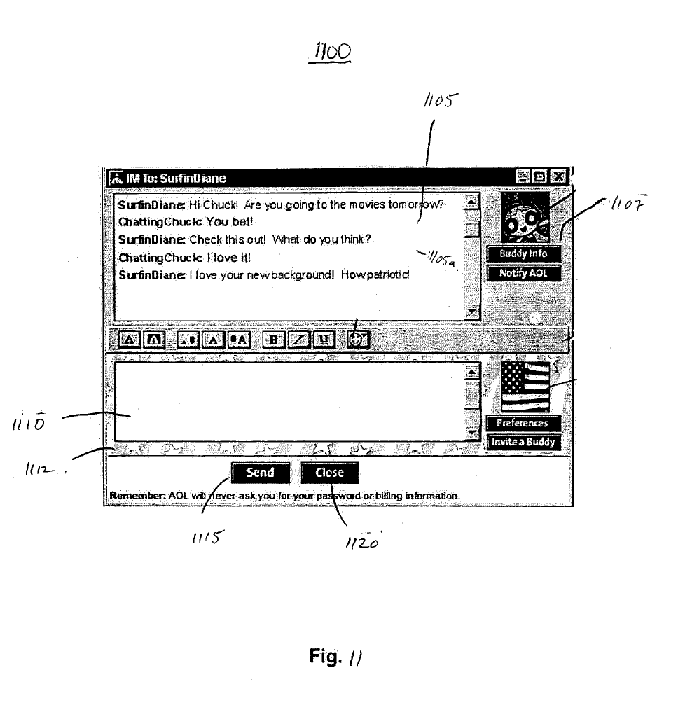

FIG. 11 illustrates one example of an IM UI 1100 that may be presented to an IM sender. The UI 1100 is rendered in response to user manipulation of the general interface tab 1020 of FIG. 10. In general, the UI 1100 is rendered on the IM sender system 105 using software stored on the IM sender system 105.

The UI 1100 includes an IM display area 1105 to display the messages 1105a of an active IM session. In the example of FIG. 11, the active IM session involves a conversation between the IM sender having a screen name of “ChattingChuck” and the IM recipient having a screen name of “SurfinDiane.” An IM compose area 1110 may be used to compose a message to send to the IM recipient in the active IM session, typically by clicking on the send control button 1115 in the UI. A control button 1120 may be provided to close the active IM session. Font and appearance controls may be provided on toolbar 1005 to control how the message being entered in the IM compose area 1110 is displayed to the IM recipient and in the IM display area 1105 once the message in the IM compose area 1110 is sent. For example, the IM sender may select control 1010 to choose, for example, an emoticon to be sent in an IM message from the IM sender to the IM recipient. The IM sender system sends the wallpaper in the IM message, and the IM recipient system renders the wallpaper.

The UI 1100 includes wallpaper 1107 from the IM recipient and wallpaper 1112 from the IM sender. In particular, as shown in FIG. 11, the IM recipient “SurfinDiane” has provided wallpaper 1107 to the IM sender “ChattingChuck.” Typically, the wallpaper 1107 is transported from the IM recipient to the IM sender by inserting the wallpaper 1107 into an instant message from the IM recipient to the IM sender. The IM sender system 105 receives the instant message containing the embedded wallpaper and renders the wallpaper 1107.

Similarly, wallpaper 1112 chosen by the IM sender may be rendered in UI 1100. When the IM sender sends an instant message to IM recipient “SurfinDiane,” wallpaper 1112 is transported along with the IM. Once received, the IM recipient system 305 renders the wallpaper 1112.

In one implementation, the IM sender may generate the instant message by manipulating a UI, such as the UI 1100 shown in FIG. 11. The UI 1100 may include wallpaper 1107 of the IM recipient (“SurfinDiane”) and wallpaper 1112 of the IM sender.

The IM sender system 105 sends the instant message with the wallpaper of the IM sender to the IM host system 310. Referring to FIG. 10, the IM sender may manipulate a general interface actionable item 1020 to render an IM sender interface 1003. The instant message may be transmitted, for example, by selecting a send control 1015.

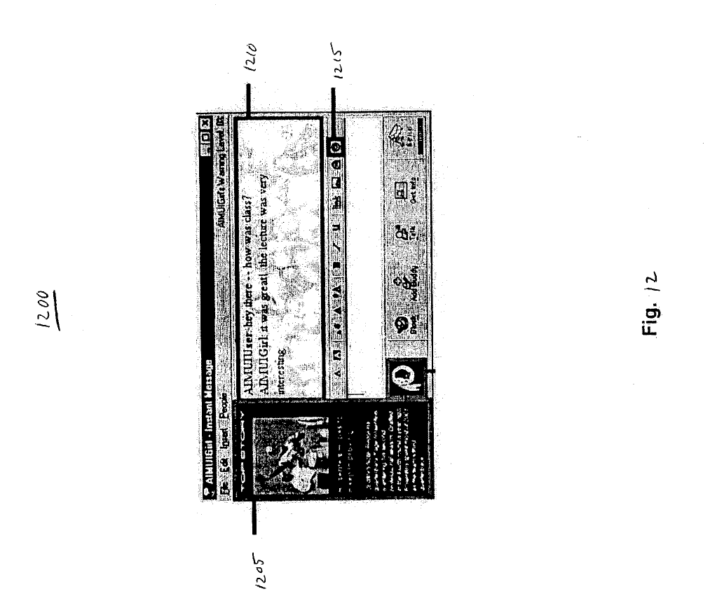

FIG. 12 illustrates yet another example of an IM UI 1200 that may be presented to an IM recipient. One or more wallpaper may be provided for the IM UI. The IM sender may select the wallpaper manually, or the wallpaper may be selected automatically for the IM sender. The wallpaper may be rendered to the IM recipient as described above with respect to FIGS. 5A and 9.

In the example of FIG. 12, an IM sender “AIMUIGIRL” may provide wallpaper 1205, 1210, 1220, and 1225 to the IM recipient “AIMMUIUSER” in the manner described above with respect to FIGS. 5A, 9, and 11. In particular, the IM sender may provide a sidebar image 1205, a background image 1210, and a sound 1225 to the IM sender. The sidebar image 1205 may include images and links to content. The background image 1210 may include an image, and typically is a washed out image. The sound 1225 may be a sound or a sequence of sounds played to the IM sender.

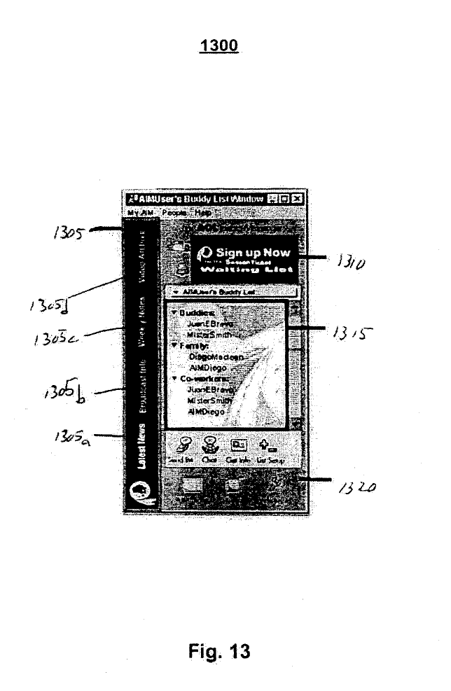

FIG. 13 is an example of an instant messaging buddy list UI 1300 that enables an IM sender of an instant messaging service to, among other things, perceive the presence state of other IM recipients that the IM sender has added to a buddy list, and to send instant messages to IM recipients on the buddy list. The buddy list may include wallpaper such as a buddy list bar 1305, a buddy list image 1310, a buddy list background image 1315, and a buddy list fill pattern 1320. The IM sender may select the wallpaper manually, or the wallpaper may be selected automatically for the IM sender. The wallpaper may be rendered to the IM sender as described above with respect to step 532 of FIG. 9 and may be made perceivable to the IM recipient as described with respect to FIGS. 5 and 9.

The buddy list bar 1305 may contain customized links 1305a, 1305b, 1305c, and 1305d to content and may have a customized appearance. The buddy list image 1310 and the buddy list background image 1315 may be, for example, image files. The buddy list background image 1315 may have a washed out appearance. The buddy list fill pattern 1320 may be a color or pattern background for the buddy list, or may also be an image. One or more of these wallpaper may be transmitted to an IM recipient and rendered on the IM recipient system 305. The transmission of the wallpaper may occur during machine-to-machine communications that are not visible to the user.

In one implementation, the IM recipient and/or the IM sender may pay a subscription fee to access/use certain wallpaper, and the wallpaper may be provided by a third party. In another implementation, the wallpaper expire and must be replaced after a predetermined event such as a predetermined length of time, passage of a predetermined date, or a predetermined number of uses. Also, a wallpaper may be banned if, for example, it is deemed to be offensive, inappropriate, or to otherwise violate a term of service agreement. If it is determined that the wallpaper is expired or banned, display of such a wallpaper will be disallowed and the user typically will be required to choose a different wallpaper.

Other implementations are within the scope of the following claims. For example, although the description above primarily refers to wallpaper, other customization items may be used, including non-buddy icons and other items that are not identifiers of a user. For instance, customization items may include sounds, animation, video clips and emoticons. Also, although the examples above are given in an instant message context, other communications systems with similar attributes may be used. For example, customization items may be used in a chat room or in e-mail communications. Also, the user interface may be a viewable interface, an audible interface, a tactile interface, or any combination of these.

What is claimed is:

1. A computer implemented method for enabling perception of wallpaper in an instant messaging communications session, the method comprising:
rendering, on an instant message recipient system, an instant messaging application user interface for an instant messaging communications session involving at least one instant message recipient and an instant message sender;
receiving a message that includes a text message and wallpaper to be displayed by the IM recipient when perceiving the text message, the wallpaper being selected by the instant message sender system; and
rendering the wallpaper at the instant message recipient system when rendering another portion of the message.

2. The method of claim 1 in which receiving the message comprises receiving wallpaper automatically selected by the instant message sender system.

3. The method of claim 1 in which receiving the message comprises receiving at least a portion of the wallpaper in an instant message from an instant message sender system.

4. The method of claim 1 in which receiving the message comprises receiving at least a portion of the wallpaper in a message generated upon a change in a presence state of the IM sender.

5. The method of claim 1 in which receiving the message comprises receiving in the message at least a portion of wallpaper provided by a host other than an instant message host.

6. The method of claim 5 in which receiving at least a portion of the wallpaper comprises receiving at least a portion of a wallpaper enabled to be rendered in consideration of a payment.

7. The method of claim 1 in which receiving the message comprises receiving at least a portion of wallpaper configured to expire upon the occurrence of a predetermined event.

8. The method of claim 7 in which the predetermined event comprises passage of a predetermined length of time or passage of a predetermined date.

9. The method of claim 7 in which the predetermined event comprises a predetermined number of uses.

10. The method of claim 7 further comprising:
determining whether the wallpaper has expired based on determining whether the predetermined event has occurred, and
disallowing display of the wallpaper if the wallpaper has expired.

11. The method of claim 1 further comprising:
determining whether the wallpaper has been banned, and
disallowing display of the wallpaper if the wallpaper has been banned.

12. The method of claim 11 in which determining whether the wallpaper has been banned comprises determining whether the wallpaper has been banned based on a report by a user.

13. The method of claim 11 in which determining whether the wallpaper has been banned comprises determining whether the wallpaper has been banned based on a violation of a term of service agreement.

14. A computer program, stored on a computer readable medium, the computer program comprising instructions for:
rendering, on an instant message recipient system, an instant messaging application user interface for an instant messaging communications session involving at least one instant message recipient and an instant message sender;
receiving a message that includes a text message and wallpaper to be displayed by the IM recipient when perceiving the text message, the wallpaper being selected by the instant message sender system; and
rendering the wallpaper at the instant message recipient system when rendering another portion of the message.

15. The computer program of claim 14 in which instructions for receiving the message comprises instructions for receiving wallpaper automatically selected by the instant message sender system.

16. The computer program of claim 14 in which instructions for receiving the message comprises instructions for receiving at least a portion of wallpaper configured to expire upon the occurrence of a predetermined event.

17. The computer program of claim 16 in which the predetermined event comprises passage of a predetermined length of time or passage of a predetermined date.

18. The computer program of claim 16 in which the predetermined event comprises a predetermined number of uses.

19. A computer implemented method for enabling transportation of wallpaper in an instant messaging communications session, the method comprising:
rendering, on an instant message sender system, an instant messaging application user interface for an instant messaging communications session involving at least one instant message recipient and an instant message sender;
accessing wallpaper to be displayed by an instant message recipient, the wallpaper being selected by the instant message sender system;
selecting an instant message recipient; and
sending a message to the selected instant message recipient, the message including at least a portion of the wallpaper associated with the instant message sender.

20. The method of claim 19 in which accessing wallpaper comprises accessing wallpaper automatically selected by the instant message sender system.

21. The method of claim 19 wherein accessing the wallpaper comprises accessing the wallpaper on the instant message sender system.

22. The method of claim 19 wherein accessing the wallpaper comprises accessing the wallpaper on an instant message host system.

23. The method of claim 19 wherein accessing the wallpaper comprises accessing the wallpaper on a host system other than an instant message host system.

24. The method of claim 19 further comprising selecting the wallpaper by the instant message sender system.

25. The method of claim 24 wherein the wallpaper is stored on an instant message host system.

26. The method of claim 24 wherein the wallpaper is stored on the instant message sender system.

27. The method of claim 19 in which sending the message comprises sending at least a portion of the wallpaper in a message generated upon a change in a presence state of the IM sender.

28. The method of claim 19 in which sending the message comprises sending in the message at least a portion of wallpaper provided by a host other than an instant message host.

29. The method of claim 28 in which sending the message comprises sending at least a portion of wallpaper enabled to be rendered in consideration of a payment.

30. The method of claim 19 in which sending the message comprises sending at least a portion of wallpaper configured to expire upon the occurrence of a predetermined event.

31. The method of claim 30 in which the predetermined event comprises passage of a predetermined length of time or passage of a predetermined date.

32. The method of claim 30 in which the predetermined event comprises a predetermined number of uses.

33. The method of claim 30 further comprising:
determining whether the wallpaper has expired based on determining whether the predetermined event has occurred, and
disallowing the sending of the wallpaper if the wallpaper has expired.

34. The method of claim 19 further comprising:
determining whether the wallpaper has been banned, and
disallowing the sending of the wallpaper if the wallpaper has been banned.

35. The method of claim 34 in which determining whether the wallpaper has been banned comprises determining whether the wallpaper has been banned based on a report by a user.

36. The method of claim 34 in which determining whether the wallpaper has been banned comprises determining whether the wallpaper has been banned based on a violation of a term of service agreement.

37. A computer program, stored on a computer readable medium, the computer program comprising instructions for:
rendering, on an instant message sender system, an instant messaging application user interface for an instant messaging communications session involving at least one instant message recipient and an instant message sender;
accessing wallpaper to be displayed by an instant message recipient, the wallpaper being selected by the instant message sender system;
selecting an instant message recipient; and
sending a message to the selected instant message recipient, the message including at least a portion of the wallpaper associated with the instant message sender.

38. The computer program of claim 37 in which instructions for accessing wallpaper comprises instructions for accessing wallpaper automatically selected by the instant message sender system.

39. The computer program of claim 37 wherein instructions for accessing the wallpaper comprises instructions for accessing the wallpaper on the instant message sender system.

40. The computer program of claim 37 wherein instructions for accessing the wallpaper comprises instructions for accessing the wallpaper on an instant message host system.

41. The computer program of claim 37 wherein instructions for accessing the wallpaper comprises instructions for accessing the wallpaper on a host system other than an instant message host system.

42. The computer program of claim 37 in which instructions for sending the message comprises instructions for sending at least a portion of the wallpaper in a message generated upon a change in a presence state of the IM sender.

43. The computer program of claim 37 in which instructions for sending the message comprises instructions for sending in the message at least a portion of wallpaper provided by a host other than an instant message host.

44. The computer program of claim 37 in which instructions for sending the message comprises instructions for sending at least a portion of wallpaper configured to expire upon the occurrence of a predetermined event.

45. The computer program of claim 44 in which the predetermined event comprises passage of a predetermined length of time or passage of a predetermined date.

46. The computer program of claim 44 in which the predetermined event comprises a predetermined number of uses.

47. The computer program of claim 44 further comprising instructions for:
determining whether the wallpaper has expired based on determining whether the predetermined event has occurred, and
disallowing the sending of the wallpaper if the wallpaper has expired.

48. The computer program of claim 37 further comprising instructions for:
determining whether the wallpaper has been banned, and
disallowing the sending of the wallpaper if the wallpaper has been banned.

49. The computer program of claim 48 in which instructions for determining whether the wallpaper has been banned comprises instructions for determining whether the wallpaper has been banned based on a report by a user.

50. The computer program of claim 48 in which instructions for determining whether the wallpaper has been banned comprises instructions for determining whether the wallpaper has been banned based on a violation of a term of service agreement.
